(19) United States
(12) Patent Application Publication
(10) Pub. No.: US 2006/0177569 A1
(43) Pub. Date: Aug. 10, 2006

(54) Method of manufacturing master disk for magnetic transfer

(75) Inventors: Nobuhiko Fujiwara, Odawara-shi (JP); Toshihiro Usa, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/325,316

(22) Filed: Jan. 5, 2006

(30) Foreign Application Priority Data
Feb. 4, 2005 (JP) 2005-029569

(51) Int. Cl. B05D 5/12; B05D 1/36

(52) U.S. Cl. 427/127; 427/402

(57) ABSTRACT

The present invention provides a method of manufacturing a master disk for magnetic transfer, comprising steps of: forming a magnetic layer on the surface of a substrate on which concavo-convex patterns are formed; forming a reverse plate made of a metal plate having a prescribed thickness by electrodepositing a metal on the surface of the substrate on which the magnetic layer is formed; and exfoliating the reverse plate from the substrate and obtaining a master disk for magnetic transfer which has, on the surface thereof, patters reverse to the concavo-convex patterns and is the reverse plate in which the magnetic layer is formed on a surface of the reverse patterns.

### BACKGROUND OF THE INVENTION

1. Field of the Invention

The present invention relates to a method of manufacturing a master disk for magnetic transfer and, more particularly, to a method of manufacturing a master disk for magnetic transfer which is suitable for transferring magnetic information patterns of format information etc. to a magnetic disk used in a hard disk device and the like.

2. Description of the Related Art

In a magnetic disk (a hard disk) used in a hard disk drive, which has rapidly come into wide use in recent years, it is general practice that format information and address information are written prior to incorporating the magnetic disk into the drive, after it is delivered from a magnetic disk manufacturer to a drive manufacturer. Although this writing can also be performed by use of a magnetic head, it is efficient and desirable to perform collective transfer from a master disk on which these format information and address information have been written.

In this magnetic transfer technology, a magnetic field generating device, such as an electromagnet device and a permanent magnet device, is disposed on one side or both sides with a master disk and a disk targeted for transfer (a slave disk) brought into close contact with each other, and magnetic fields are applied for transfer whereby magnetization patterns corresponding to information (for example, servo signals) on the master disk are transferred.

As an example of a master disk used in such magnetic transfer, there has been proposed a master disk in which concavo-convex patterns corresponding to information signals are formed on the surface of a substrate and a thin-film magnetic layer is coated on the surface of the concavo-convex patterns (refer to the Japanese Patent Application Laid-Open No. 2001-256644, for example).

The concavo-convex patterns on the master disk are drawn by irradiating a disk, to which photoresist has been applied, with laser beams or electron beams modulated depending on the information, while the disk is rotated. Using sputtering and the like, a conductive layer is formed on the surface of the original disk having concavo-convex patterns obtained by developing the photoresist. Plating (electroforming) is then performed on this conductive layer to mold a metal into a metal disk which, after removed, is used as a master disk to copy the concavo-convex shapes onto the surface of a substrate.

### SUMMARY OF THE INVENTION

However, in such a master disk for magnetic transfer, concavo-convex patterns of magnetic layers for performing magnetic transfer are obtained by fabricating a substrate having, on its surface, concavo-convex shapes which correspond to transfer information and are rectangular in section and by coating the concavo-convex shapes of this substrate with a magnetic layer. Therefore, the sectional shape of the surface of the coated magnetic layer becomes asymmetric and in a case where magnetic transfer is performed onto a slave disk by use of such a master disk, transferred magnetic patterns tend to include noise and hence an improvement is desired in terms of the quality of transfer signals.

In this way, the surface of a substrate which is coated with a magnetic layer has concavo-convex shapes the section of which is rectangular. Therefore, if the substrate surface is coated with a magnetic layer in a uniform thickness, the sectional shape of the surface of the magnetic layer would also obtain rectangular concavo-convex shapes. However, the thickness of the coated magnetic layer is affected by the surface shape of the substrate and the sectional shape of the surface of the magnetic layer often becomes what is called a mushroom shape.

In other words, in a master disk in which the concavo-convex patterns of a substrate are coated with a magnetic layer, the concavo-convex shapes of the surface of the magnetic layer do not cause the concavo-convex shapes of the substrate on the bottom surface of the magnetic layer to appear accurately. For example, phenomena of widened width of convexities, curved surfaces formed at the corners of convexities and the like occur, and the thicker the magnetic layer, the more remarkable such phenomena will be.

And it has been found that magnetic patterns transferred by use of this master disk tend to include noise and have an influence on the quality of transfer signals, positional accuracy, etc.

The present invention has been made in view of such circumstances and has as its object the provision of a method of manufacturing a master disk having excellent transfer characteristics, in which the section of a magnetic layer has good concavo-convex shapes and as a result of this, there are few noise components associated with magnetic transfer.

To achieve the above object, the present invention provides a method of manufacturing a master disk for magnetic transfer which comprises the steps of: forming a magnetic layer on the surface of a substrate on which concavo-convex patterns are formed; forming a reverse plate made of a metal plate having a prescribed thickness by electrodepositing a metal on the surface of the substrate on which the magnetic layer is formed; and exfoliating the reverse plate from the substrate and obtaining a master disk for magnetic transfer which has, on the surface thereof, patters reverse to the concavo-convex patterns and is the reverse plate in which the magnetic layer is formed on a surface of the reverse patterns.

According to the present invention, unlike a usual method of manufacturing a master disk for magnetic transfer, a magnetic layer is first formed on the surface of a substrate on which a large number of fine concavo-convex patterns are formed, a reverse plate is then formed on the magnetic layer by electrodepositing a metal, and subsequently, the reverse plate is exfoliated from the substrate, whereby a master disk for magnetic transfer which is the reverse plate is obtained. Therefore, the concavo-convex patterns on the surface of the magnetic layer cause the concavo-convex shapes of the substrate on the bottom surface of the magnetic layer to appear accurately, with the result that it is possible to obtain a master disk for magnetic transfer having excellent transfer characteristics in which there are few noise components associated with magnetic transfer.

Also, according to the present invention, unlike a usual method of manufacturing a master disk for magnetic transfer, the step of forming a conductive layer on the surface of an original plate (or a substrate) by sputtering and the like becomes unnecessary. Therefore, in addition to the saving of the step, the equipment cost of a film forming device etc. is saved, thereby contributing to a cost reduction.

The present invention also provides a method of manufacturing a master disk for magnetic transfer which comprises the steps of: forming a magnetic layer on the surface of a substrate on which concavo-convex patterns are formed; forming a reverse plate formed from a resin plate having a prescribed thickness by applying a resin liquid to the surface of the substrate on which the magnetic layer is formed and curing the resin liquid; and exfoliating the reverse plate from the substrate and obtaining a master disk for magnetic transfer which has, on the surface thereof, patters reverse to the concavo-convex patterns and is the reverse plate in which the magnetic layer is formed on a surface of the reverse patterns.

According to the present invention, in place of the above-described step of electrodepositing a metal on a metal on the surface of the substrate, a reverse plate is formed by applying a resin liquid to the surface of the substrate and curing the resin liquid. Therefore, as described above, the concavo-convex patterns on the surface of the magnetic layer cause the concavo-convex shapes of the substrate on the bottom surface of the magnetic layer to appear accurately, with the result that it is possible to obtain a master disk for magnetic transfer having excellent transfer characteristics in which there are few noise components associated with magnetic transfer.

In the present invention, it is preferred that the method of manufacturing a master disk for magnetic transfer further comprises, before the step of the magnetic layer, a protective film forming step of forming a hard protective film on the surface of the substrate. With this constitution which enables a hard protective film to be formed on the surface of the substrate, tolerance to the damages and the like due to the friction occurred in the process of contact with a slave disk can be imparted to a master disk for magnetic transfer.

In the present invention, it is also preferred that the method of manufacturing a master disk for magnetic transfer further comprises, after the step of forming the magnetic layer, a step of forming a conductive film on the surface of the substrate. If one conductive layer is formed like this, it is possible to obtain also the effect that the electrodeposition of a metal can be uniformly performed.

In the present invention, it is preferred that the conductive film be a film which contains Ni as a main component. Such a film which contains Ni as a main component is easy to form and is suitable as a conductive film.

In the present invention, it is preferred that the magnetic layer be a film which contains FeCo or FeCoNi as a main component. With a magnetic layer which contains FeCo or FeCoNi as a main component, it is possible to make magnetization patterns of a master disk good.

In the present invention, it is also preferred that the substrate be a plate-like body which is formed by: a resist coating step of applying a resist agent to a flat surface of a wafer and forming a layer of the resist agent; a resist patterning step of forming an opening of the layer of the resist agent on the surface of the wafer by drawing and exposure to the layer of the resist agent and development treatment thereafter; an etching step of removing the wafer in the opening of the layer of the resist agent from the surface of the wafer by a prescribed depth; and an ashing step of removing the layer of the resist agent.

With photofabrication in which patterning by a resist agent and etching are combined like this, concavo-convex patterns of fine shapes can be formed with good accuracy. Therefore, this substrate is desirable as a substrate used in the manufacturing process of a master disk for magnetic transfer.

As described above, according to the present invention, the concavo-convex patterns on the surface of the magnetic layer cause the concavo-convex shapes of the substrate on the bottom surface of the magnetic layer to appear accurately, with the result that it is possible to obtain a master disk for magnetic transfer having excellent transfer characteristics in which there are few noise components associated with magnetic transfer.

### BRIEF DESCRIPTION OF THE DRAWINGS

FIG. 1 is a partially enlarged perspective view of a master disk manufactured by a method of manufacturing a master disk for magnetic transfer related to the present invention;

FIG. 2 is a plan view of a master disk for magnetic transfer; and

FIGS. 3A to 3F are sectional views which show each step in order in manufacturing a master disk for magnetic transfer.

### DETAILED DESCRIPTION OF THE PREFERRED EMBODIMENTS

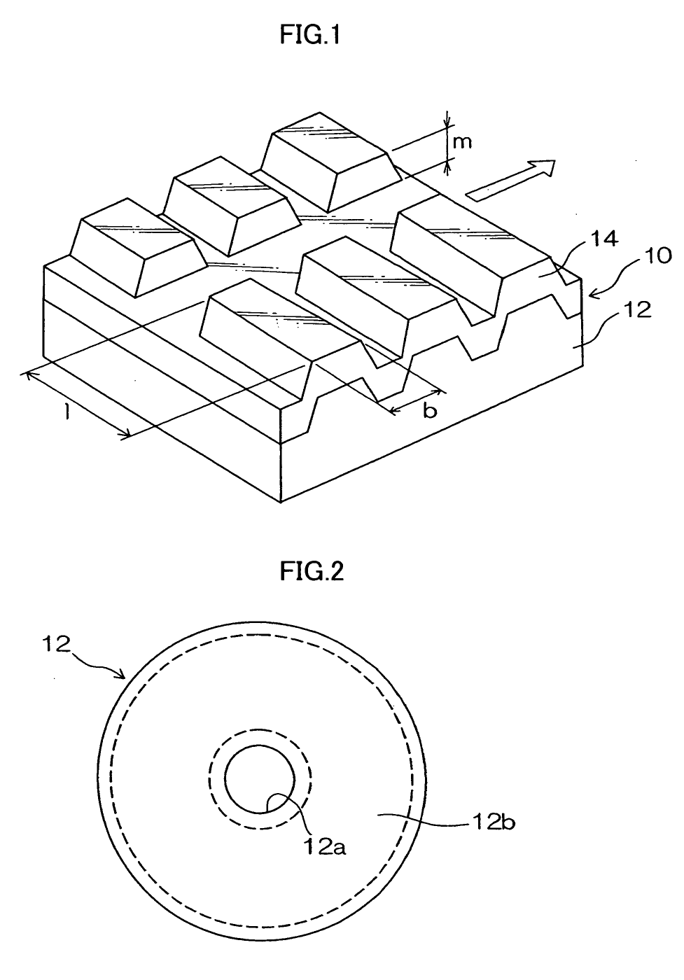

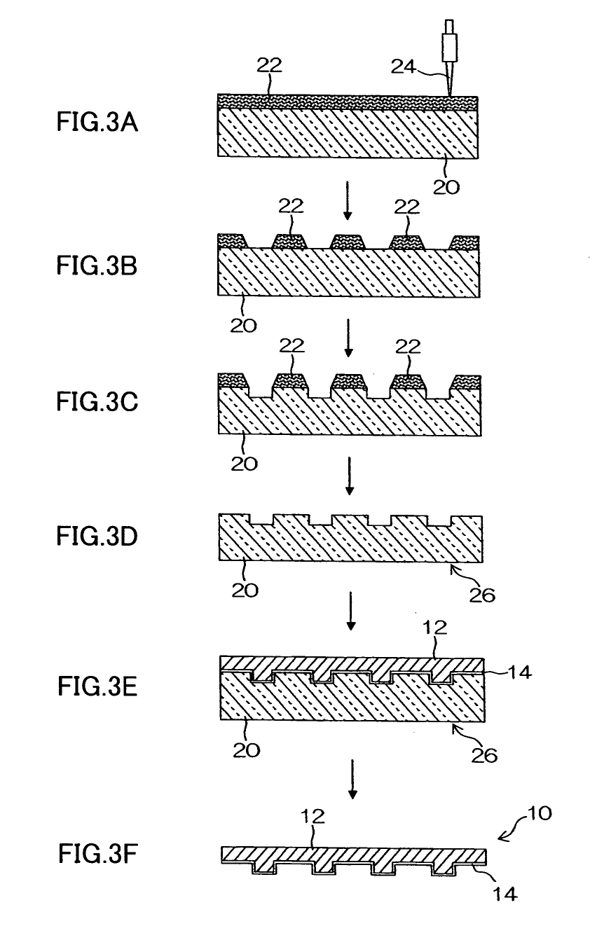

Hereinafter, a preferred embodiment (the first embodiment) of a method of manufacturing a master disk for magnetic transfer related to the present invention will be described in detail with reference to the attached drawings. FIG. 1 is a partially enlarged perspective view of a master disk manufactured by a method of manufacturing a master disk for magnetic transfer related to the present invention. FIG. 2 is a plan view of a master disk for magnetic transfer. FIGS. 3A to 3F are sectional views which show each step in order in manufacturing a master disk for magnetic transfer according to a method of manufacturing a master disk for magnetic transfer of the invention. Incidentally, each of the views is a schematic one, which is indicated at a ratio different from an actual size.

First, a master disk manufactured by a method of manufacturing a master disk for magnetic transfer related to the present invention will be described. As shown in FIG. 1, a master disk for magnetic transfer 10 is constituted by a master substrate 12 made of metal and a magnetic layer 14, the master substrate 12 has, on the surface thereof, fine concavo-convex patterns corresponding to transfer information and the surface is coated with the magnetic layer 14.

In FIG. 1, a transfer information carrying surface, on which fine protruding patterns by the magnetic layer 14 are formed, is formed on one surface of the master a substrate 12, and the opposite surface of the master substrate 12 is held by a close contacting device which is not shown. The formation of the fine protruding patterns is performed by a photofabrication process, which will be described later, and the like. One surface (the transfer information carrying surface) of the master disk 10 is a surface which is brought into close contact with a slave disk.

The fine protruding patterns are rectangular as plan viewed and, with the magnetic layer 14 having a thickness m formed, each protrusion is composed of a length b in the direction of tracks (the direction of the thick arrow in the figure) and a radial length l. Although optimum values of the length b and the length l differ depending on recording density, the waveform of a recording signal, etc., it is possible to set the length b at 80 nm and the length l at 200 nm, for example.

This fine protruding pattern is formed to be radially elongated in the case of a servo signal. In this case, it is preferred that the radial length l be 0.05 to 20 μm and that the length in the direction of tracks (the circumferential length) be 0.05 to 5 μm. It is preferred that a pattern which is radially long in these ranges be selected as a pattern which carries the information of a servo signal.

The depth of the fine protruding patters (the height of the protrusions) on the surface of the master substrate 12 is preferably in the range of 20 to 800 nm, and more preferably in the range of 30 to 600 nm.

In the master disk 10, magnetic transfer is possible with this master substrate 12 alone when the master substrate 12 is formed from a ferromagnetic material mainly composed of Ni etc., and hence the magnetic layer 14 does not always require coating. However, better magnetic transfer can be performed by providing a magnetic layer 14 having good transfer characteristics. When the master substrate 12 is formed of a nonmagnetic material as in the second embodiment described below, it is necessary to provide the magnetic layer 14. It is preferred that the magnetic layer 14 of the master disk 10 be a soft magnetic layer having a coercive force Hc of not more than 48 kA/m (≦600 Oe).

When the master substrate 12 is formed from a ferromagnetic material mainly composed of Ni etc., the master substrate 12 can be fabricated by electroforming. In this case, as shown in FIG. 2, the master disk 12 can be formed in the shape of a disk having a center hole 12a and concavo-convex patterns can be formed in an annular region 12b excepting an inner circumferential part and an outside diameter part on one surface.

This master substrate 12 is fabricated, as will be described later, by forming the magnetic layer 14 on an original disk on which concavo-convex patterns corresponding to information are formed, then laminating a metal plate of a specified thickness by electrodepositing Ni etc., exfoliating this metal plate from the original disk, and punching an outer circumferential part and the part of the center hole 12a with desired sizes.

Next, a manufacturing method of the master disk 10 will be described on the basis of FIGS. 3A to 3F. First, as shown in FIG. 3A, an original plate 20 which is a silicon wafer (a glass plate, a quartz glass plate may also be used) having a smooth surface is subjected to base material treatment, such as adhesive layer formation. Subsequently, a resist layer 22 is formed by applying an electron-beam resist liquid by the spin coat process etc., and baking treatment (prebake) is performed.

Then, the original plate 20 is set on a stage of an electron-beam exposure device (not shown) which is provided with a high-accuracy rotary stage or X-Y stage. The original plate 20 is irradiated with electron beams 24 which have been modulated in response to servo signals while the original plate 20 is being rotated, and on substantially the whole surface of the photoresist layer 22, a prescribed pattern, for example, a pattern corresponding to a servo signal which extend linearly in the radial direction in each track from the center of rotation is drawn and exposed in portions corresponding to each frame on the circumference.

Subsequently, as shown in FIG. 3B, the resist layer 22 is subjected to development treatment, whereby exposed portions are removed and a coating layer of a desired thickness by the remaining resist layer 22 is formed. This coating layer becomes a mask in the next step (the etching step). After the development treatment, baking treatment (postbake) is performed in order to increase the adhesion between the resist layer 22 and the original plate 20.

Subsequently, as shown in FIG. 3C, the original plate 20 is removed (etched) from the opening of the resist layer 22 by a specified depth from the surface. In this etching, in order to minimize the undercut (side etching), it is desirable to perform anisotropic etching. RIE (Reactive Ion Etching) can be preferably adopted as such anisotropic etching.

Subsequently, as shown in FIG. 3D, the resist layer 22 is removed. In removing the resist layer 22, ashing can be adopted as a dry method and a removal method by a remover liquid as a wet method. As a result of the above-described ashing step, an original disk 26 on which a reverse form of desired concavo-convex patterns are formed is fabricated.

Subsequently, thin films are formed on the surface of the original disk 26 shown in FIG. 3D in uniform thicknesses in order of a hard protective film, a magnetic layer and a conductive film. Incidentally, the hard protective film and the conductive film are not essential features of the present invention.

A protective film of diamond-like carbon (DLC) etc. is preferable as the hard protective film, and a lubricant layer may be further provided on the hard protective film. In this case, a preferred film construction is a diamond-like carbon film having a thickness of 5 to 30 nm as a protective film plus a lubricant film. Also, an adhesion enforcing layer of Si etc. may be provided between the magnetic layer 14 and a protective film. A lubricant is effective in improving the deterioration of durability, such as the occurrence of flaws due to friction during the correction of misalignment which occurs in the process of contact with a slave disk.

The magnetic layer 14 (magnetic layer) is formed from a magnetic material by use of vacuum film formation device, such as the vacuum evaporation process, the sputtering process and the ionplating process, the plating process (including the electroless platin), etc. As magnetic materials for the magnetic layer 14, it is possible to use Co, Co alloys (CoNi, CoNiZr, CoNbTaZr, etc.), Fe, Fe alloys (FeCo, FeCoNi, FeNiMo, FeAlSi, FeAl, FeTaN), Ni, and Ni alloys (NiFe).

In particular, FeCo and FeCoNi can be preferably used. The thickness t of the magnetic layer 14 is preferably in the range of 50 nm to 500 nm, and more preferably in the range of 100 nm to 400 nm.

Various metal film forming processes including PVD (Physical Vapor Deposition), CVD (Chemical Vapor Deposition), sputtering and ionplating can be applied as methods of forming a conductive film. If one conductive layer is formed like this, it is possible to obtain also the effect that the electrodeposition of a metal can be uniformly performed. A film which contains Ni as a main component is preferable as a conductive film. It is preferred that the conductive film be a film which contains Ni as a main component. Such a film which contains Ni as a main component is easy to form and is suitable as a conductive film. Although there is no limitation to the film thickness of this conductive film, tens of nanometers can be generally adopted.

Subsequently, as shown in FIG. 3E, a metal plate of a desired thickness, which is formed from a Ni metal, is laminated on the surface of the original disk 26 by performing electrodeposition (electroforming) (the reverse plate forming step). Incidentally, in FIG. 3E, only the magnetic layer 14 is shown and the illustration of the hard protective film and the conductive film is omitted.

This electrodeposition is performed by immersing the original disk 26 in an electrolyte in the electroforming device and applying current to a cathode, with the original disk 26 serving as an anode. It is required that the concentration of the electrolyte, pH, how to apply current, etc. during the electrodeposition should be under optimum conditions which ensure that the laminated metal plate (i.e., the master substrate 12) is free from strain.

And after the electrodeposition is completed as described above, the original disk 26 which is laminated with the metal plate (i.e., the master substrate 12) is taken out of the electrolyte in the electroforming device and immersed in the pure water within an exfoliation bath (not shown).

In the exfoliation step, the metal plate (i.e., the master substrate 12) is exfoliated from the original disk 26 within the exfoliation bath. And the master substrate 12 having concavo-convex patterns reverse to the patterns of the original disk 26 as shown in FIG. 3F is obtained. And the inside diameter and outside diameter of the master substrate 12 are punched with prescribed sizes, whereby the master disk for magnetic transfer 10 is obtained.

In the method of manufacturing such a master disk for magnetic transfer 10, unlike a usual method of manufacturing a master disk for magnetic transfer, the magnetic layer 14 is first formed on the surface of the original plate 20 on which a large number of fine concavo-convex patterns are formed, then the master substrate 12, which is a reverse plate, is formed by electrodepositing a metal on the magnetic layer 14. Subsequently the master substrate 12 is exfoliated from the original plate 20, whereby the master disk for magnetic transfer 10, which is a reverse plate, is obtained.

Therefore, the concavo-convex shapes on the surface of the magnetic layer 14 cause the concavo-convex shapes of the original plate 20 on the bottom surface of the magnetic layer to appear accurately, with the result that it is possible to obtain a master disk for magnetic transfer 10 having excellent transfer characteristics in which there are few noise components associated with magnetic transfer.

Also, according to the present invention, unlike a usual method of manufacturing a master disk for magnetic transfer, the step of forming a conductive layer on the surface of the original plate 20 (or the substrate) by sputtering and the like becomes unnecessary. Therefore, in addition to the saving of the step, the equipment cost of a film forming device etc. is saved, thereby contributing to a cost reduction.

Next, another embodiment (the second embodiment) of a method of manufacturing a master disk for magnetic transfer related to the present invention will be described. In this embodiment, a reverse plate forming method by use of a resin is adopted in place of electrodeposition (electroforming) in the step of forming the reverse plate (refer to FIG. 3E) of the above-described first embodiment. And other steps are the same as in the first embodiment. Therefore, only the step of forming the reverse plate will be described.

In the reverse plate forming step, a reverse form of desired concavo-convex patterns is formed, a resin liquid is applied to the surface of the original disk 26, which is a substrate on which the magnetic layer 14 is formed, and the resin liquid is cured, whereby the master substrate 12 which is a reverse plate of prescribed thickness, which is made of a resin plate, is formed.

In this reverse plate forming step, it does not matter what kind of material is used for the resin liquid so long as it has a viscosity permitting the resin liquid to be filled in the interior of the concavo-convex patterns on the surface of the original disk 26 and provides good dimensional stability after hardening.

A radiation curing type resin liquid can be preferably adopted as this resin liquid. That is, if a low-viscosity resin liquid is filled in the interior of the concavo-convex patterns on the surface of the original disk 26 and after that, the resin liquid cures due to the radiation of radiant rays, then dimensional stability is not impaired by the expansion or contraction of the original disk 26 due to the heat of resin, which occurs in the case of thermosetting resins and thermoplastic resins.

An ultraviolet-curing type resin is generally used as this radiation curing type resin. This ultraviolet-curing type resin is composed of a photopolymerizing monomer and a polymerization initiator. Publicly known resins which polymerize by the activation energy rays of ultraviolet rays, electron rays, etc. can be used in this ultraviolet curing resin. A photopolymerizing monomer is formed from a compound having a polymerizing functional group, such as a radical polymerizing unsaturated group and an epoxy group.

For the viscosity of an ultraviolet curing resin, resins having viscosities of 1 to 2000 mPa·s in a noncured condition can be used and those having viscosities of 1000 to 2000 mPa·s in a noncured condition can be preferably used. Also, those which easily undergo plastic deformation at degrees of polymerization of 70 to 80% or so and are not easily deformed in a complete polymerization state are preferable. Also, those little shrink during curing are preferable.

As a resin curing device which cures an ultraviolet curing resin by irradiation, it is preferable to use a resin curing device which cures an ultraviolet curing resin by exposing the resin to light and can radiate light having a wavelength corresponding to the curing characteristics of the ultraviolet curing resin.

According to the second embodiment of the present invention, in place of the step of electrodepositing a metal on the surface of the original disk 26 in the above-described first embodiment, a resin liquid is applied to the surface of the original disk 26 and the resin liquid is cured, whereby the reverse plat is formed. Therefore, in the same manner as in the above-described first embodiment, the concavo-convex shapes on the surface of the magnetic layer 14 cause the concavo-convex shapes of the original disk 26 on the bottom surface of the magnetic layer 14 to appear accurately, with the result that it is possible to obtain a master disk for magnetic transfer 10 having excellent transfer characteristics in which there are few noise components associated with magnetic transfer.

Embodiments of a method of manufacturing a master disk for magnetic transfer related to the present invention were described above. However, the present invention is not limited to the above-described embodiments and it is possible to adopt various other embodiments.

For example, in the embodiments, after the formation of the magnetic layer 14 on the original disk 26, the master substrate 12 is obtained by electrodepositing a metal. However, it is possible to adopt another manufacturing process. Concretely, it is possible to adopt a mode of fabricating a second original disk by electrodepositing a metal on an original disk 26, forming a magnetic layer 14 by use of this second original disk, then fabricating a metal plate (a reverse plate) having reverse concavo-convex patterns by electrodepositing a metal again, and fabricating a master disk for magnetic transfer 10 by punching the metal plate (the reverse plate) with a prescribed size.

With this method, the effect that multiple second original disks can be fabricated from one original disk 26 is obtained. However, because it is difficult to generate a difference between the adhesive force of the magnetic layer 14 to the second original disk and the adhesive force of the magnetic layer 14 to the metal plate (the reverse plate) deposited to this second original disk, it is preferred that release treatment be performed before the formation of the magnetic layer 14 on the second original disk.

Similarly, it is possible to adopt a mode of further fabricating a third original disk by performing electrodeposition by use of a second original disk, forming a magnetic layer 14 by use of the third original disk, and then fabricating a metal plate by performing electrodeposition, whereby a master disk 10 is fabricated.

Incidentally, even in a case where the concavo-convex patterns of the master substrate 12 of the master disk 10 are negative patters of concavo-convex shapes reverse to the positive patters of FIG. 3F, there is no problem because similar magnetization patters can be transferred and recorded by reversing the direction of an initial magnetic field Hi and the direction of a magnetic field for transfer Hd during magnetic transfer.

What is claimed is:

1. A method of manufacturing a master disk for magnetic transfer, comprising the steps of:
forming a magnetic layer on a surface of a substrate on which concavo-convex patterns are formed;
forming a reverse plate made of a metal plate having a prescribed thickness by electrodepositing a metal on the surface of the substrate on which the magnetic layer is formed; and
exfoliating the reverse plate from the substrate and obtaining a master disk for magnetic transfer which has, on the surface thereof, patters reverse to the concavo-convex patterns and is the reverse plate in which the magnetic layer is formed on a surface of the reverse patterns.

2. The method of manufacturing a master disk for magnetic transfer according to claim 1, wherein the metal which is electrodeposited contains Ni as a main component.

3. The method of manufacturing a master disk for magnetic transfer according to claim 1, further comprising:
a protective film forming step of forming a hard protective film on the surface of the substrate before the step of forming the magnetic layer.

4. The method of manufacturing a master disk for magnetic transfer according to claim 1, further comprising:
a conductive film forming step of forming a conductive film on the surface of the substrate after the step of forming the magnetic layer.

5. The method of manufacturing a master disk for magnetic transfer according to claim 1, wherein the magnetic layer is a layer which contains FeCo or FeCoNi as a main component.

6. The method of manufacturing a master disk for magnetic transfer according to claim 1, wherein the step of forming the magnetic layer is performed by sputtering or electroless plating.

7. The method of manufacturing a master disk for magnetic transfer according to claim 1,
wherein the substrate is formed by the steps of applying a resist agent to a flat surface of a wafer and forming a layer of the resist agent, forming an opening of the layer of the resist agent on the surface of the wafer by drawing and exposure to the layer of the resist agent and development treatment thereafter, removing the wafer in the opening of the layer of the resist agent from the surface of the wafer by a prescribed depth, and removing the layer of the resist agent.

8. The method of manufacturing a master disk for magnetic transfer according to claim 2, further comprising:
a protective film forming step of forming a hard protective film on the surface of the substrate before the step of forming the magnetic layer.

9. The method of manufacturing a master disk for magnetic transfer according to claim 2, further comprising:
a conductive film forming step of forming a conductive film on the surface of the substrate after the step of forming the magnetic layer.

10. The method of manufacturing a master disk for magnetic transfer according to claim 2, wherein the magnetic layer is a layer which contains FeCo or FeCoNi as a main component.

11. The method of manufacturing a master disk for magnetic transfer according to claim 2, wherein the step of forming the magnetic layer is performed by sputtering or electroless plating.

12. The method of manufacturing a master disk for magnetic transfer according to claim 2,
wherein the substrate is formed by the steps of applying a resist agent to a flat surface of a wafer and forming a layer of the resist agent, forming an opening of the layer of the resist agent on the surface of the wafer by drawing and exposure to the layer of the resist agent and development treatment thereafter, removing the wafer in the opening of the layer of the resist agent from the surface of the wafer by a prescribed depth, and removing the layer of the resist agent.

13. The method of manufacturing a master disk for magnetic transfer according to claim 3, further comprising:
a conductive film forming step of forming a conductive film on the surface of the substrate after the step of forming the magnetic layer.

14. The method of manufacturing a master disk for magnetic transfer according to claim 13, wherein the conductive film is a film which contains Ni as a main component.

15. A method of manufacturing a master disk for magnetic transfer, comprising steps of:
forming a magnetic layer on a surface of a substrate on which concavo-convex patterns are formed;
forming a reverse plate formed from a resin plate having a prescribed thickness by applying a resin liquid to the surface of the substrate on which the magnetic layer is formed and curing the resin liquid; and
exfoliating the reverse plate from the substrate and obtaining a master disk for magnetic transfer which has, on the surface thereof, patters reverse to the concavo-convex patterns and is the reverse plate in which the magnetic layer is formed on a surface of the reverse patterns.

16. The method of manufacturing a master disk for magnetic transfer according to claim 15, further comprising:
a protective film forming step of forming a hard protective film on the surface of the substrate before the step of forming the magnetic layer.

17. The method of manufacturing a master disk for magnetic transfer according to claim 15, wherein the magnetic layer is a layer which contains FeCo or FeCoNi as a main component.

18. The method of manufacturing a master disk for magnetic transfer according to claim 15, wherein the step of forming the magnetic layer is performed by sputtering or electroless plating.

19. The method of manufacturing a master disk for magnetic transfer according to claim 15,
wherein the substrate is formed by the steps of applying a resist agent to a flat surface of a wafer and forming a layer of the resist agent, forming an opening of the layer of the resist agent on the surface of the wafer by drawing and exposure to the layer of the resist agent and development treatment thereafter, removing the wafer in the opening of the layer of the resist agent from the surface of the wafer by a prescribed depth, and removing the layer of the resist agent.
